(19) United States
(12) Patent Application Publication
(10) Pub. No.: US 2025/0346133 A1
(43) Pub. Date: Nov. 13, 2025

(54) POWER STORAGE SYSTEM

(71) Applicant: HONDA MOTOR CO., LTD., Tokyo (JP)

(72) Inventors: Katsuya SHIMAZAKI, Saitama (JP); Yasushi OGIHARA, Saitama (JP); Yasuo YAMADA, Saitama (JP); Shuji KAMATA, Saitama (JP)

(73) Assignee: HONDA MOTOR CO., LTD., Tokyo (JP)

(21) Appl. No.: 19/204,613

(22) Filed: May 12, 2025

(30) Foreign Application Priority Data
May 13, 2024 (JP) 2024-077852

(51) Int. Cl. B60L 53/24; B60L 50/51; B60L 50/60; B60L 53/62; H02M 1/14; H02M 7/797

(52) U.S. Cl. CPC B60L 53/24; B60L 50/51; B60L 50/60; B60L 53/62; H02M 1/14; H02M 7/797; B60L 2210/10

(57) ABSTRACT

A system includes: a battery including a switch group configured to switch a connection state of a plurality of power storage; a three-phase motor; an inverter; a DC power supply circuit connected to a first connection portion positioned on an electric power transmission path between the inverter and the battery; an auxiliary device; and a drive circuit connected to a second connection portion on an electric power transmission path between the inverter and the first connection portion. The DC power supply circuit on a positive electrode side includes a branch circuit connected to a coil of one phase among coils of three phases at a third connection portion, the branch circuit is connected to the drive circuit at a fourth connection portion via a first switch, and the drive circuit has a second changeover switch between the second connection portion and the fourth portion.

### CROSS-REFERENCE TO RELATED APPLICATIONS

This application is based on and claims priority under 35 USC 119 from Japanese Patent Application No. 2024-077852 filed on May 13, 2024, the contents of which are incorporated herein by reference.

### TECHNICAL FIELD

The present disclosure relates to a power storage system.

### BACKGROUND

In recent years, researches and developments have been conducted on charging and power feeding in a vehicle mounted with a secondary battery that contributes to an increase in energy efficiency in order to allow more users to access affordable, reliable, sustainable, and advanced energy.

In relation to charging and power supply in a vehicle including a secondary battery, there are two types of charging equipment such as charging stations: a 400 V class with an upper limit voltage of 500 V, and an 800 V class with an upper limit voltage of 1000 V. When a vehicle is compatible with only the charging equipment of 400 V class, the vehicle cannot enjoy quick charging performance of the charging equipment of 800 V class.

In a case where the vehicle is compatible with both the 400 V class charging equipment and the 800 V class charging equipment, generally, a voltage is boosted to 800 V by a voltage converter when charging by the 400 V class charging equipment, or the voltage is stepped down to 400 V by the voltage converter when charging by the 800 V class charging equipment. However, using such a voltage converter for charging deteriorates efficiency during charging.

In this regard, there is a vehicle in which a connection system of a battery module is switched so as to be chargeable by both the 400 V class charging equipment and the 800 V class charging equipment without using any voltage converter for charging (for example, Japanese Patent Application Laid-Open Publication No. 2019-080474 and No. 2020-150618).

By the way, there are two types of auxiliary devices used in a vehicle, one is driven at the 400 V class and the other one is driven at the 800 V class.

In the vehicle in which the connection system of the battery module is switched, voltage conversion is generally performed by a voltage converter for auxiliary devices, for example, when a 400 V class auxiliary device is to be driven during charging by the 800 V class charging equipment, or when an 800 V class auxiliary device is to be driven during charging by the 400 V class charging equipment. However, such a voltage converter for auxiliary devices is expensive and thus a manufacturing cost increases.

Moreover, in recent years, a charging method using a higher voltage and a lower current has been proposed in order to reduce a burden on a power distribution unit and terminals of a charging system for vehicles. In a 1200 V class charging equipment with an upper limit voltage of 1500 V, the burden on the power distribution unit and terminals of the charging system can be reduced as compared with the 400 V class charging equipment and 800 V class charging equipment.

For example, when an output of the charging equipment is 320 kW, theoretically, a current of 800 A flows in the 400 V class charging equipment, and a current of 400 A flows in the 800 V class charging equipment. On the other hand, in the 1200 V class charging equipment, a current can be decreased to 265 A.

In this way, for vehicles that can be charged by charging equipment with different upper limit voltages by switching a connection system of a battery module, there is a demand for a power storage system that can operate auxiliary devices without using expensive voltage converters for auxiliary devices.

### SUMMARY

An aspect of the present disclosure relates to a power storage system including:
a battery including a plurality of power storage units and a switch group configured to switch a connection state of the plurality of power storage units between a first voltage state, a second voltage state, and a third voltage state, the first voltage state being a state in which the battery is configured to be charged at a first voltage, the second voltage state being a state in which the battery is configured to be charged at a second voltage higher than the first voltage, the third voltage state being a state in which the battery is configured to be charged at a third voltage higher than the second voltage;
a three-phase motor in which coils of three phases are connected at a neutral point, the three-phase motor being driven by electric power supplied from the battery;
an inverter connected to an electric power transmission path between the battery and the three-phase motor;
a DC power supply circuit connected to a first connection portion positioned on an electric power transmission path between the inverter and the battery;
an auxiliary device configured to be driven by DC power from the battery and an external power supply; and
an auxiliary device drive circuit that is connected to a second connection portion on an electric power transmission path between the inverter and the first connection portion and supplies electric power to the auxiliary device, in which
the DC power supply circuit on a positive electrode side includes a branch circuit connected to a coil of one phase among the coils of three phases at a third connection portion,
the branch circuit is connected to the auxiliary device drive circuit at a fourth connection portion via a first changeover switch, and
the auxiliary device drive circuit has a second changeover switch between the second connection portion and the fourth connection portion.

### BRIEF DESCRIPTION OF DRAWINGS

Exemplary embodiments of the present invention will be described in detail based on the following figures, wherein

FIG. 1 is a diagram showing a configuration of a power storage system 1 according to a first embodiment;

FIG. 2 is a diagram showing a configuration of a battery 2;

FIG. 3 is a diagram showing a configuration of an inverter 5 of the power storage system 1 of FIG. 1;

FIG. 4 is a diagram showing a first voltage state (400 V start-up state) of the battery 2;

FIG. 5 is a diagram showing a second voltage state (800 V start-up state) of the battery 2;

FIG. 6 is a diagram showing a third voltage state (1200 V start-up state) of the battery 2;

FIG. 7 is a diagram showing a flow of a current during traveling of an electric vehicle including the power storage system 1 according to a first embodiment;

FIG. 8 is a diagram showing a flow of a current during charging at a first voltage (400 V) of the electric vehicle including the power storage system 1 according to the first embodiment;

FIG. 9 is a diagram illustrating a booster operation of the inverter 5;

FIG. 10 is a diagram illustrating the booster operation of the inverter 5;

FIG. 11 is a diagram showing a flow of a current during charging at a second voltage (800 V) of the electric vehicle including the power storage system 1 according to the first embodiment;

FIG. 12 is a diagram showing a flow of a current during charging at a third voltage (1200 V) of the electric vehicle including the power storage system 1 according to the first embodiment;

FIG. 13 is a diagram illustrating a step-down operation of the inverter 5;

FIG. 14 is a diagram illustrating the step-down operation of the inverter 5;

FIG. 15 is a table summarizing states of switches and contactors in each mode of the power storage system 1 of the first embodiment;

FIG. 16 is a flowchart showing a control flow of the power storage system 1;

FIG. 17 is a diagram showing a configuration of the power storage system 1 according to a second embodiment;

FIG. 18 is a diagram showing a flow of a current during traveling of the electric vehicle including the power storage system 1 according to the second embodiment;

FIG. 19 is a diagram showing a flow of a current during charging at the first voltage (400 V) of the electric vehicle including the power storage system 1 according to the second embodiment;

FIG. 20 is a diagram showing a flow of a current during charging at the second voltage (800 V) of the electric vehicle including the power storage system 1 according to the second embodiment;

FIG. 21 is a diagram showing a flow of a current during charging at the third voltage (1200 V) of the electric vehicle including the power storage system 1 according to the second embodiment; and

FIG. 22 is a table summarizing states in each mode of the power storage system 1 of the second embodiment.

### DESCRIPTION OF EMBODIMENTS

Hereinafter, embodiments of the present disclosure will be described with reference to the drawings.

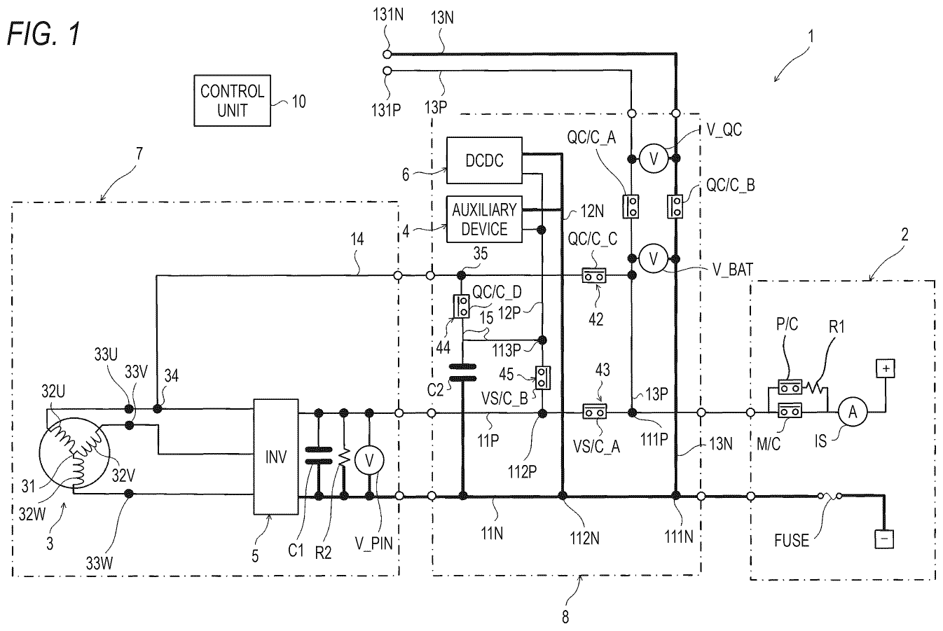

First, a first embodiment of the present disclosure will be described with reference to FIGS. 1 to 16.

### First Embodiment

A power storage system 1 according to the first embodiment shown in FIG. 1 is mounted on an electric vehicle such as an electric automobile. The electric vehicle including the power storage system 1 is compatible with charging equipment of 400 V class with an upper limit voltage of 500 V, 800 V class with an upper limit voltage of 1000 V, and 1200 V class with an upper limit voltage of 1500 V. The electric vehicle 1 not only can quickly charge a battery 2 at charge voltages of 400 V, 800 V, and 1200 V but also can drive a three-phase motor 3 and an auxiliary device 4 at a base voltage of 800 V. Note that the charge voltages of 400 V, 800 V, and 1200 V are merely examples, and the power storage system 1 is not limited by these voltages, and the charge voltages may be any voltages as long as charging by charging equipment with different upper limit voltages is possible.

Specifically, as shown in FIG. 1, the power storage system 1 includes the battery 2, the three-phase motor 3, the auxiliary device 4, an inverter 5 (INV), a DC-DC converter 6, electric power supply circuits 11P and 11N, auxiliary device drive circuits 12P and 12N, DC power supply circuits 13P and 13N, a branch circuit 14, and a control unit 10. In FIG. 1, reference numeral 7 denotes a drive unit, and reference numeral 8 denotes an auxiliary unit.

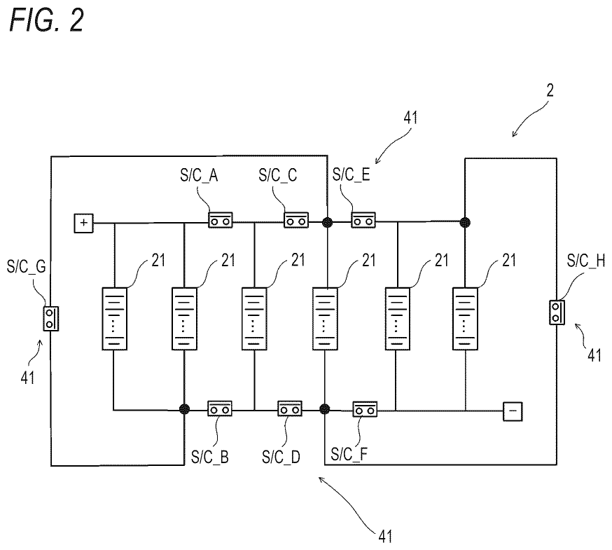

As shown in FIGS. 1 and 2, the battery 2 includes six power storage units 21, a first switch unit 41, a main contactor M/C, a pre-charge contactor P/C, a first resistor R1, a current sensor IS, and a current breaker FUSE.

The power storage units 21 are battery modules which can be charged and supply power at 400 V.

The main contactor M/C is provided on a positive electrode side end of the battery 2 and functions as a main switch which turns on and off connection to the outside (the electric power supply circuit 11P) of the battery 2.

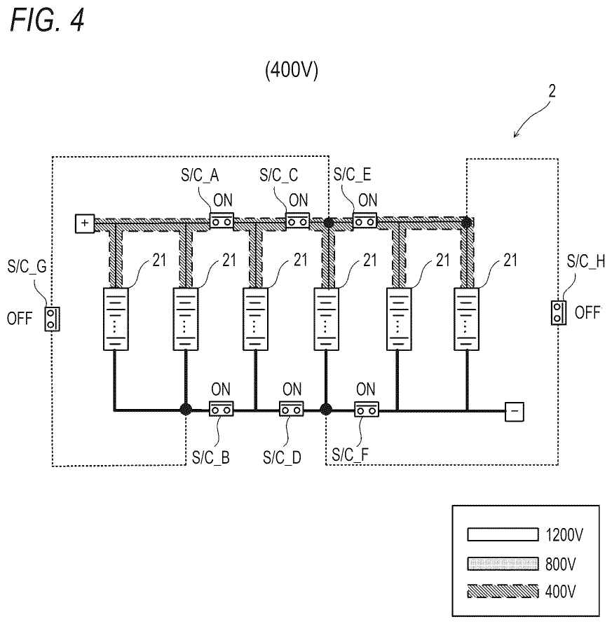

As shown in FIG. 2, the first switch unit 41 includes, for example, eight switches (S/C_A, S/C_B, S/C_C, S/C_D, S/C_E, S/C_F, S/C_G, and S/C_H). The eight switches constitute an example of a switch group, and switch a connection state of the six power storage units 21 of the battery 2. In a first voltage state shown in FIG. 4 in which the six power storage units 21 are connected in parallel, the battery 2 can be charged and supply power at 400 V. Hereinafter, this first voltage state capable of charging and supplying power at 400 V will also be referred to as a 400 V start-up state.

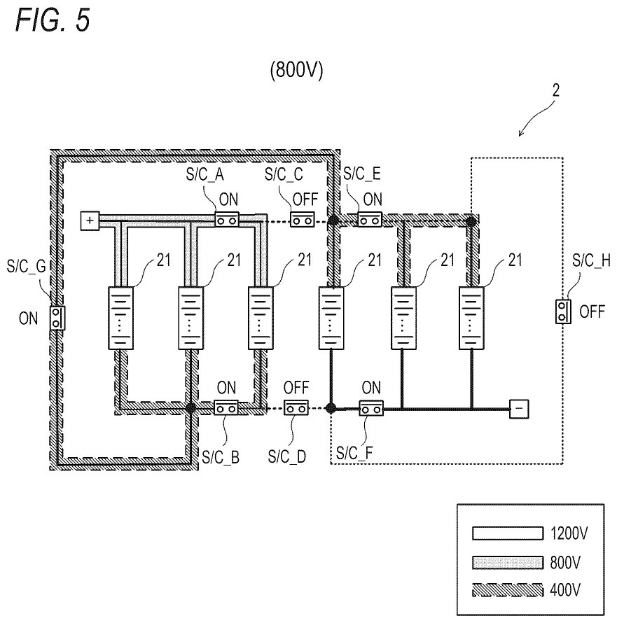

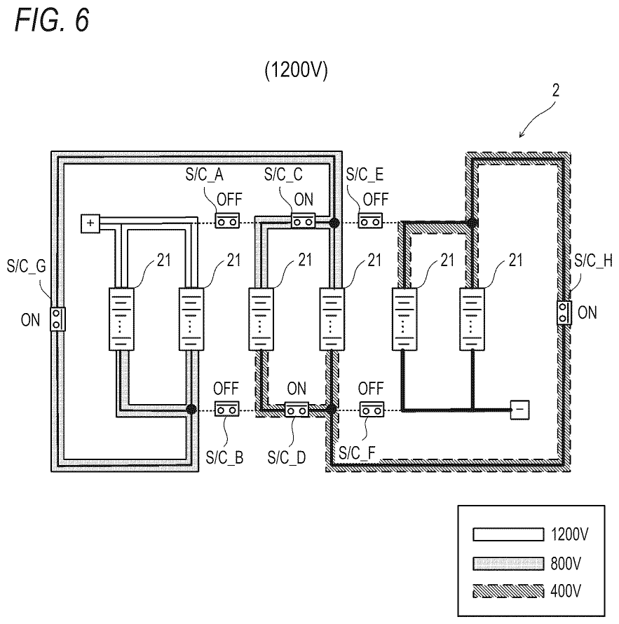

In a second voltage state shown in FIG. 5 in which two groups of three power storage units 21 connected in parallel are connected in series with each other, the battery 2 can be charged and supply power at 800 V. Hereinafter, this second voltage state capable of charging and supplying power at 800 V will also be referred to as an 800 V start-up state. Furthermore, in a third voltage state shown in FIG. 6 in which three groups of two power storage units 21 connected in parallel are connected in series with each other, the battery 2 can be charged and supply power at 1200 V. Hereinafter, this third voltage state capable of charging and supplying power at 1200 V will also be referred to as a 1200 V start-up state.

Returning to FIG. 1, the pre-charge contactor P/C and the first resistor R1 are arranged in series with each other and in parallel with the main contactor M/C. When pre-charging a smoothing capacitor C1, the pre-charge contactor P/C is turned on before the main contactor M/C is turned on, thereby protecting the main contactor M/C from an excessive inrush current. The pre-charge contactor P/C is maintained in an OFF state except when pre-charging the smoothing capacitor C1.

The current sensor IS is disposed between the main contactor M/C and the six power storage units 21, and measures currents.

The current breaker FUSE is provided on a negative electrode side end of the battery 2 and cuts off the connection to the outside (the electric power supply circuit 11N) of the battery 2 when an abnormality occurs. In the power storage system 1 according to the present embodiment, the current breaker FUSE is implemented by a pyro-fuse which can intentionally cut off a current according to an electrical signal. When an abnormality occurs (for example, vehicle collision or a short circuit in the battery 2), the current breaker FUSE performs a cut-off operation, and all the contactors in the battery 2 are turned off (opened).

The three-phase motor 3 includes coils 32U, 32V, and 32W of three phases, one end side of each of which is connected to a neutral point 31, and is rotationally driven by electric power supplied from the battery 2 via the inverter 5. The three-phase motor 3 in the present embodiment includes a U-phase terminal 33U, a V-phase terminal 33V, and a W-phase terminal 33W connected to the other end side of each of the coils 32U, 32V, and 32W, respectively. The U-phase terminal 33U, the V-phase terminal 33V, and the W-phase terminal 33W are connected to the inverter 5. The other end side of a coil of any one phase among the coils 32U, 32V, and 32W is connected to the branch circuit 14 at a third connection portion 34. In the present embodiment, the U-phase coil 32U among the coils 32U, 32V, and 32W of three phases is connected to the branch circuit 14 at the third connection portion 34 positioned between the U-phase terminal 33U and the inverter 5.

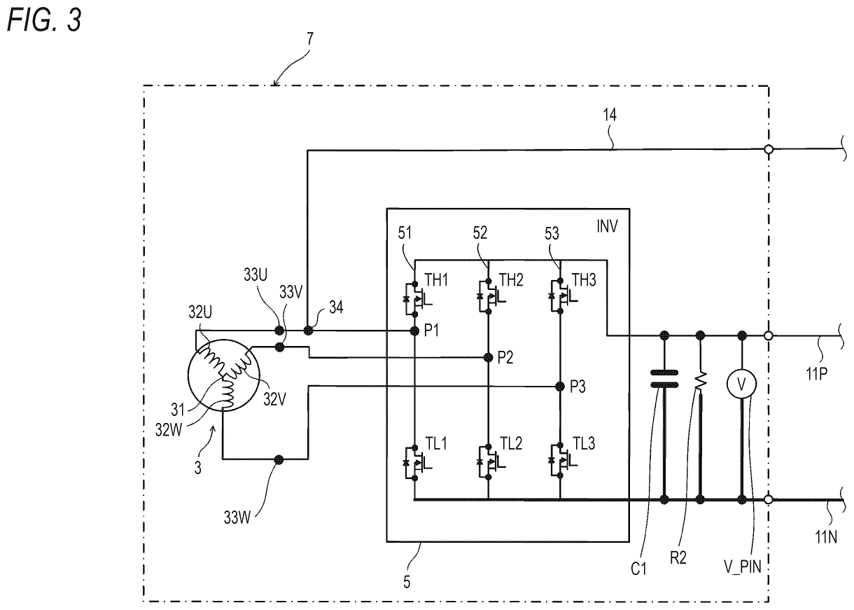

The inverter 5 converts DC power supplied from the battery 2 into three-phase AC power by switching of a plurality of switching elements, so as to rotationally drive the three-phase motor 3. As shown in FIG. 3, the inverter 5 includes a first branch circuit 51 including a first high-side switch TH1, a first low-side switch TL1, and a first node P1 connecting the first high-side switch TH1 and the first low-side switch TL1 in series, a second branch circuit 52 including a second high-side switch TH2, a second low-side switch TL2, and a second node P2 connecting the second high-side switch TH2 and the second low-side switch TL2 in series, and a third branch circuit 53 including a third high-side switch TH3, a third low-side switch TL3, and a third node P3 connecting the third high-side switch TH3 and the third low-side switch TL3 in series. Each of the first branch circuit 51, the second branch circuit 52, and the third branch circuit 53 has a high-side switch side end connected in parallel with the electric power supply circuit 11P on the positive electrode side, and a low-side switch side end connected in parallel with the electric power supply circuit 11N on the negative electrode side.

The first node P1 is connected to the U-phase terminal 33U and thereby connected to the coil 32U, the second node P2 is connected to the V-phase terminal 33V and thereby connected to the coil 32V, and the third node P3 is connected to the W-phase terminal 33W and thereby connected to the coil 32W. The switches TH1, TL1, TH2, TL2, TH3, and TL3 are semiconductor switches, and are implemented by, for example, MOSFETs, whose opening and closing control is performed by the control unit 10 by adjusting a gate voltage.

A diode operating as a reflux diode is connected in parallel with each of the switches TH1, TL1, TH2, TL2, TH3, and TL3. The reflux diodes are provided to prevent damage to the switching elements by causing a current flowing back from the three-phase motor 3 side to reflux (regenerate) to the battery 2 side when the switches TH1, TL1, TH2, TL2, TH3, and TL3 are turned off. That is, the inverter 5 allows a current to flow from the three-phase motor 3 side to the battery 2 side regardless of an ON or OFF state of a gate, and allows a current to flow from the battery 2 side to the three-phase motor 3 side only when the gate is in an ON state.

As will be described in detail later, during 400 V charging, when a voltage of 400 V is supplied from the branch circuit 14 to the third connection portion 34, the power storage system 1 can cause the three-phase motor 3 to function as a part of a boost circuit by switching the switches TH1, TL1, TH2, TL2, TH3, and TL3. During 1200 V charging, when a voltage of 1200 V is supplied from the electric power supply circuit 11P to the inverter 5, the power storage system 1 can cause the three-phase motor 3 to function as a part of a step-down circuit by switching the switches TH1, TL1, TH2, TL2, TH3, and TL3.

The auxiliary device 4 is a high-voltage driven in-vehicle device which can be driven by DC power from the battery 2 and an external power supply, and examples thereof includes an electric compressor or a heater for air-conditioning. The auxiliary device 4 is connected to the battery 2 via the auxiliary device drive circuits 12P and 12N, and the electric power supply circuits 11P and 11N, which will be described later. The auxiliary device 4 is also configured to be connectable to an external power supply via the auxiliary device drive circuits 12P and 12N, the electric power supply circuits 11P and 11N, and the DC power supply circuits 13P and 13N, which will be described later. Furthermore, the auxiliary device 4 is configured to be connectable to the three-phase motor 3 via a connecting flow path 15 and the branch circuit 14, which will be described later. The auxiliary device 4 according to the present embodiment operates at the base voltage of 800 V.

The DC-DC converter 6 is connected in parallel with the auxiliary device 4 to the auxiliary device drive circuit 12P, and steps down the DC power from the battery 2 and the external power supply to drive a low-voltage driven in-vehicle device.

The electric power supply circuits 11P and 11N are configured as a positive and negative pair and connect the battery 2 and the inverter 5 (three-phase motor 3). The electric power supply circuits 11P and 11N are provided with first connection portions 111P and 111N as connection portions with the DC power supply circuits 13P and 13N, and are provided with second connection portions 112P and 112N as connection portions with the auxiliary device drive circuits 12P and 12N on a side closer to the inverter 5 than the first connection portions 111P and 111N. The electric power supply circuit 11P on the positive electrode side is provided with a third switch unit 43 which turns on and off a circuit between the second connection portion 112P as a connection portion with the auxiliary device drive circuit 12P and the first connection portion 111P as a connection portion with the DC power supply circuit 13P. The third switch unit 43 is implemented by a contactor VS/C_A. The contactor VS/C_A is, for example, an electromagnetic contactor. Therefore, when the third switch unit 43 (contactor VS/C_A) is in an ON state, electric power transmission between the first connection portion 111P and the second connection portion 112P is allowed, and when the third switch unit 43 (contactor VS/C_A) is in an OFF state, electric power transmission between the first connection portion 111P and the second connection portion 112P is cut off.

A first voltage sensor V_PIN, the smoothing capacitor C1 and a second resistor R2 are provided on the inverter 5 side of the electric power supply circuits 11P and 11N. The first voltage sensor V_PIN, the smoothing capacitor C1, and the second resistor R2 are provided on a circuit that connects the electric power supply circuit 11P on the positive electrode side and the electric power supply circuit 11N on the negative electrode side. Note that the second resistor R2 is provided to discharge the smoothing capacitor C1 when the circuit is cut off.

The DC power supply circuits 13P and 13N are configured as a positive and negative pair and include one end provided with charge terminals 131P and 131N to which an external power supply such as charging equipment can be connected and the other end connected to the electric power supply circuits 11P and 11N via the first connection portions 111P and 111N. The DC power supply circuits 13P and 13N are provided with a contactor QC/C_A and a contactor QC/C_B for turning on and off the circuits, respectively. The contactor QC/C_A and the contactor QC/C_B are, for example, electromagnetic contactors. When the contactor QC/C_A and the contactor QC/C_B are in an ON state, electric power supply from the external power supply to the electric power supply circuits 11P and 11N is allowed, and when the contactor QC/C_A and the contactor QC/C_B are in an OFF state, electric power supply from the external power supply to the electric power supply circuits 11P and 11N is cut off.

In the DC power supply circuits 13P and 13N, a second voltage sensor V_BAT is provided at a position closer to the first connection portions 111P and 111N than the contactor QC/C_A and the contactor QC/C_B. A third voltage sensor V_QC is provided at a position closer to the charge terminals 131P and 131N than the contactor QC/C_A and the contactor QC/C_B.

The auxiliary device drive circuits 12P and 12N are configured as a positive and negative pair and include one end to which the auxiliary device 4 and the DC-DC converter 6 are connected in parallel and the other end connected to the electric power supply circuits 11P and 11N via the second connection portions 112P and 112N. The auxiliary device drive circuit 12P on the positive electrode side is provided with a fifth switch unit 45 that switches the circuit between an ON state and an OFF state. The fifth switch unit 45 is implemented by a contactor VS/C_B. The contactor VS/C_B is, for example, an electromagnetic contactor. Therefore, when the contactor VS/C_B is in an ON state, electric power is supplied from the DC power supply circuit 13P on the positive electrode side to the auxiliary device 4 and the DC-DC converter 6. On the other hand, when the contactor VS/C_B is in an OFF state, electric power supply from the DC power supply circuit 13P on the positive electrode side to the auxiliary device 4 and the DC-DC converter 6 is cut off.

The branch circuit 14 is branched, in the DC power supply circuit 13P at the positive electrode side, at a position closer to the first connection portion 111P than the contactor QC/C_A and the second voltage sensor V_BAT and is connected to any one of the coils of the three-phase motor 3 via the third connection portion 34. The branch circuit 14 is provided with a second switch unit 42 that turns on and off the circuit, and the connecting flow path 15 that branches off from a fifth connection portion 35 that is positioned closer to the third connection portion 34 than the second switch unit 42 and is connected to the auxiliary device drive circuit 12P.

The second switch unit 42 is implemented by a contactor QC/C_C. The contactor QC/C_C is, for example, an electromagnetic contactor. Therefore, when the second switch unit 42 (contactor QC/C_C) is in an ON state, electric power transmission between the DC power supply circuit 13P on the positive electrode side and the branch circuit 14 is allowed, and when the second switch unit 42 (contactor QC/C_C) is in an OFF state, electric power transmission between the DC power supply circuit 13P on the positive electrode side and the branch circuit 14 is cut off.

The connecting flow path 15 is connected to the auxiliary device drive circuit 12P on the positive electrode side at a fourth connection portion 113P. The connecting flow path 15 is provided with a fourth switch unit 44 for turning on and off the circuit. The fourth switch unit 44 is implemented by a contactor QC/C_D. The contactor QC/C_D is, for example, an electromagnetic contactor. Therefore, when the fourth switch unit 44 (contactor QC/C_D) is in an ON state, electric power is supplied from the branch circuit 14 to the auxiliary device drive circuit 12P, and when the fourth switch unit 44 (contactor QC/C_D) is in an OFF state, the electric power supply from the branch circuit 14 to the auxiliary device drive circuit 12P is cut off.

The connecting flow path 15 is connected to one end of the smoothing capacitor C2, the other end of which is connected to the electric power supply circuit 11N on the negative electrode side, between the fourth switch unit (contactor QC/C_D) and the fourth connection portion 113P.

The control unit 10 is, for example, a vehicle ECU and controls driving and charging of the power storage system 1. More specifically, the control unit 10 controls the first to fifth switch units 41 to 45 and the ON/OFF state of each contactor (including PWM control), the DC-DC converter 6, and the inverter 5.

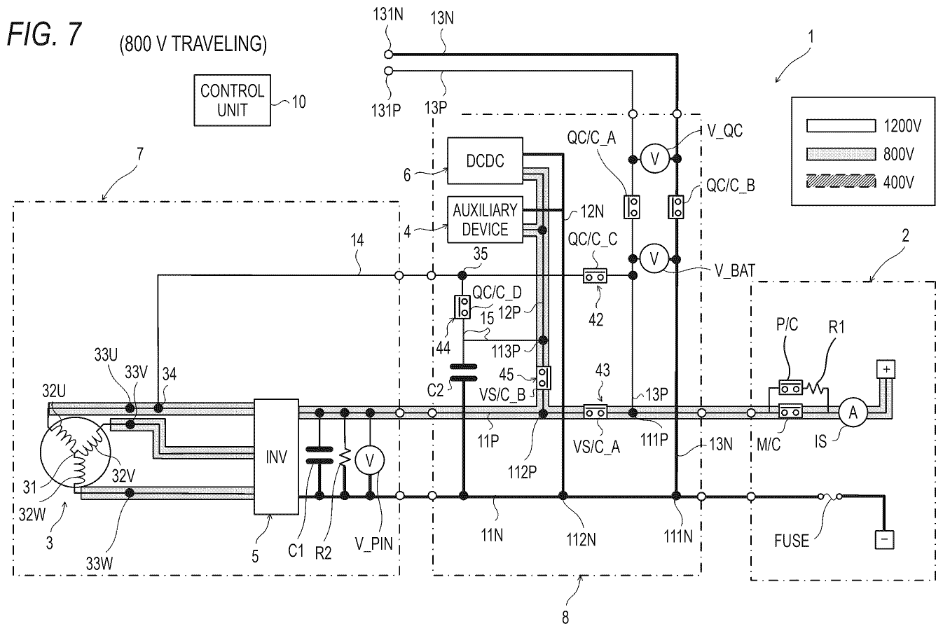

Next, an operation of the power storage system 1 will be described with reference to FIGS. 7 to 14.

FIG. 7 is a diagram showing a flow of a current during traveling (800 V traveling) of an electric vehicle including the power storage system 1 according to the first embodiment.

As described above, the electric vehicle including the power storage system 1 drives the three-phase motor 3 and the auxiliary device 4 with the base voltage of 800 V, and during traveling, the battery 2 is controlled to the 800 V start-up state shown in FIG. 5. The control unit 10 turns on the main contactor M/C, the third switch unit 43 (contactor VS/C_A), and the fifth switch unit 45 (contactor VS/C_B), and turns off the contactor QC/C_A, the contactor QC/C_B, the second switch unit 42 (contactor QC/C_C), and the fourth switch unit 44 (contactor QC/C_D). A circuit mode in this case is called a first mode.

In this first mode, a voltage of 800 V is supplied from the battery 2 to the three-phase motor 3 via the inverter 5, enabling the electric vehicle to travel. In this case, the auxiliary device 4 is driven by a voltage of 800 V supplied from the battery 2 via the electric power supply circuits 11P and 11N and the auxiliary device drive circuits 12P and 12N.

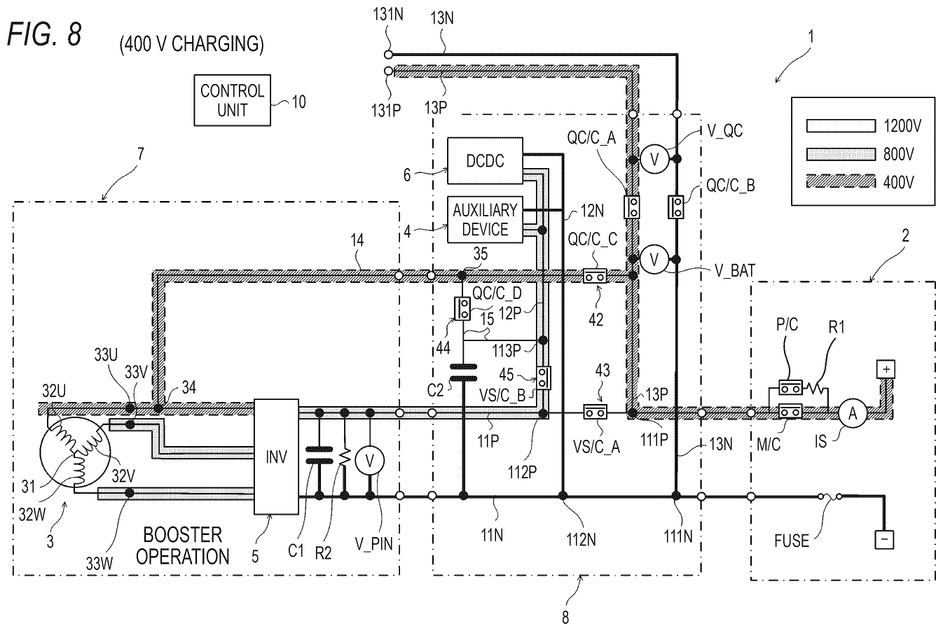

FIG. 8 is a diagram showing a flow of a current during charging at the first voltage (400 V charging) of the electric vehicle including the power storage system 1 according to the first embodiment.

When charging with a 400 V class charging equipment, the battery 2 is controlled to a 400 V start-up state shown in FIG. 4. The control unit 10 turns on the main contactor M/C, the contactor QC/C_A, the contactor QC/C_B, the second switch unit 42 (contactor QC/C_C), and the fifth switch unit 45 (contactor VS/C_B), and turns off the third switch unit 43 (contactor VS/C_A) and the fourth switch unit 44 (contactor QC/C_D). A circuit mode in this case is called a fourth mode. As a result, a voltage of 400 V is supplied from the charge terminals 131P and 131N to the battery 2 via the DC power supply circuit 13P and the electric power supply circuit 11P, and a voltage of 400 V is supplied to the coil 32U via the DC power supply circuit 13P and the branch circuit 14.

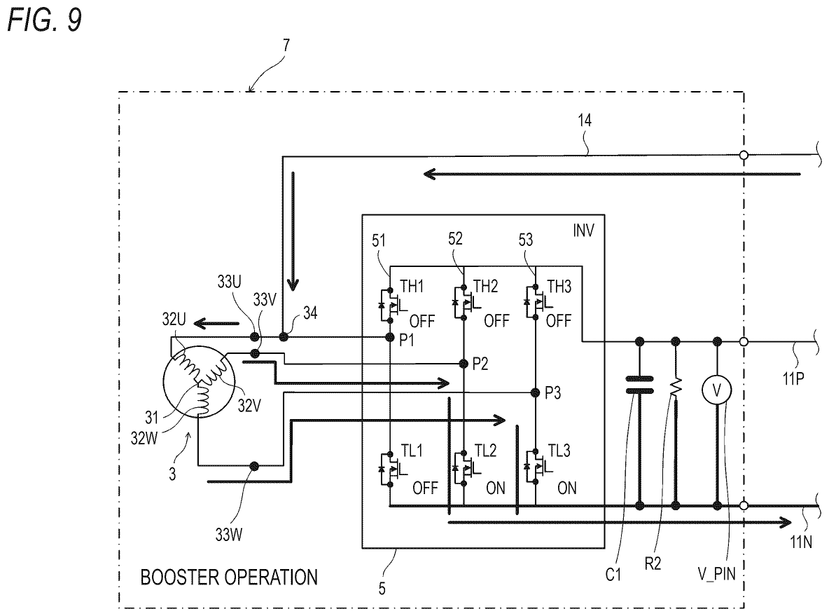

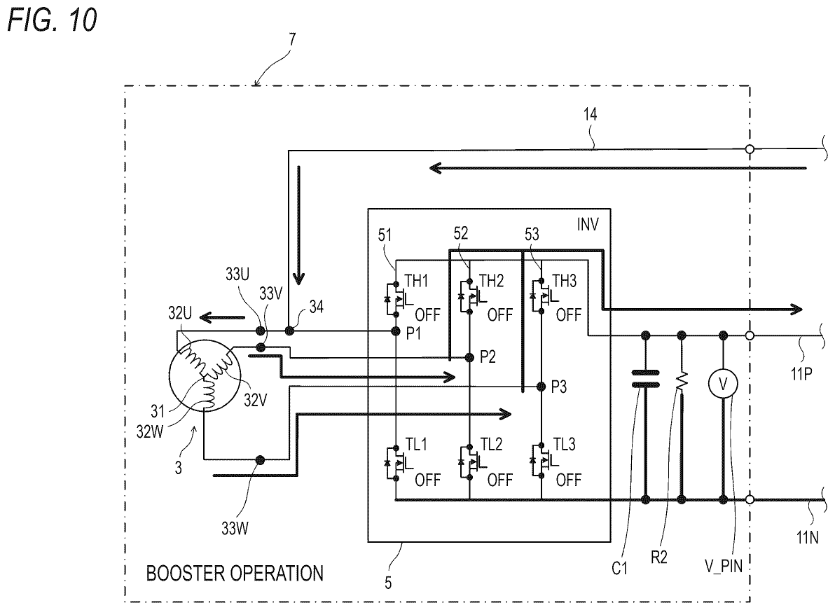

Here, in order to drive the auxiliary device 4 having a base voltage of 800 V, it is necessary to boost the voltage of 400 V to 800 V, which is the base voltage of the auxiliary device 4. Therefore, the control unit 10 performs high-frequency switching of the second low-side switch TL2 and the third low-side switch TL3 to perform a booster operation of switching between ON states of the second low-side switch TL2 and the third low-side switch TL3 shown in FIG. 9 and OFF states of the second low-side switch TL2 and the third low-side switch TL3 shown in FIG. 10. Note that the other switches TL1 and TH1 to TH3 of the inverter 5 are maintained in the OFF state.

As a result, the energy stored in the coils 32U, 32V, and 32W when the second low-side switch TL2 and the third low-side switch TL3 are in the ON state shown in FIG. 9 is released when the second low-side switch TL2 and the third low-side switch TL3 are in the OFF state shown in FIG. 10, so that the voltage of 400 V supplied from the charge terminals 131P and 131N is boosted to 800 V and supplied from the inverter 5 to the auxiliary device 4 via the electric power supply circuit 11P and the auxiliary device drive circuit 12P.

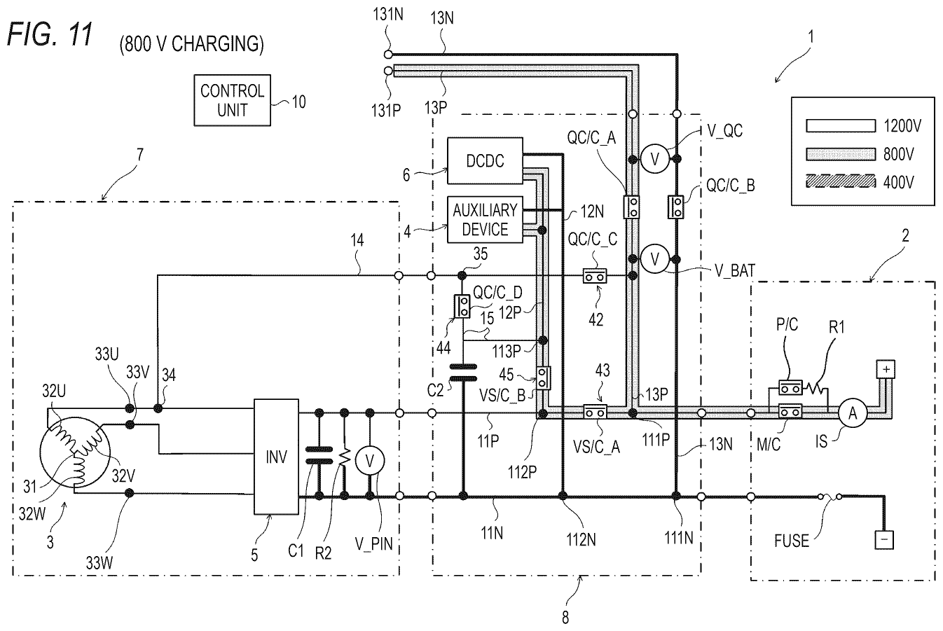

FIG. 11 is a diagram showing a flow of a current during charging at the second voltage (800 V charging) of the electric vehicle including the power storage system 1 according to the first embodiment.

When charging with an 800 V class charging equipment, the battery 2 is controlled to an 800 V start-up state shown in FIG. 5. The control unit 10 turns on the main contactor M/C, the contactor QC/C_A, the contactor QC/C_B, the third switch unit 43 (contactor VS/C_A), and the fifth switch unit 45 (contactor VS/C_B), and turns off the second switch unit 42 (contactor QC/C_C) and the fourth switch unit 44 (contactor QC/C_D). A circuit mode in this case is called a third mode. As a result, a voltage of 800 V is supplied from the charge terminals 131P and 131N to the battery 2 via the DC power supply circuit 13P and the electric power supply circuit 11P, and a voltage of 800 V is supplied to the auxiliary device 4 via the DC power supply circuit 13P, the electric power supply circuit 11P, and the auxiliary device drive circuit 12P.

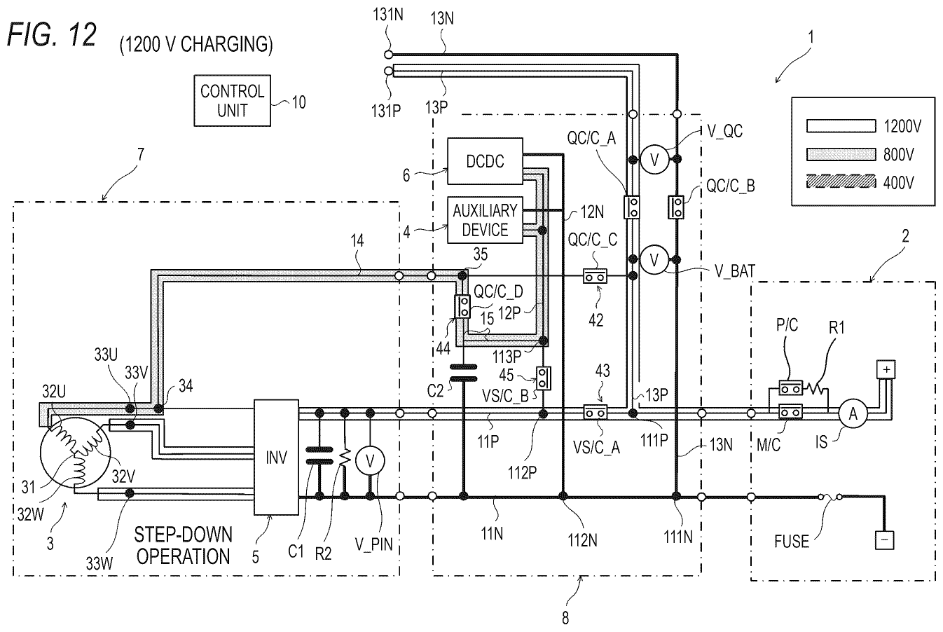

FIG. 12 is a diagram showing a flow of a current during charging at the third voltage (1200 V charging) of the electric vehicle including the power storage system 1 according to the first embodiment.

When charging with a 1200 V class charging equipment, the battery 2 is controlled to a 1200 V start-up state shown in FIG. 6. The control unit 10 turns on the main contactor M/C, the contactor QC/C_A, the contactor QC/C_B, the third switch unit 43 (contactor VS/C_A), and the fourth switch unit 44 (contactor QC/C_D), and turns off the second switch unit 42 (contactor QC/C_C) and the fifth switch unit 45 (contactor VS/C_B). A circuit mode in this case is called a second mode. As a result, a voltage of 1200 V is supplied from the charge terminals 131P and 131N to the battery 2 via the DC power supply circuit 13P and the electric power supply circuit 11P, and a voltage of 1200 V is supplied to the inverter 5 via the DC power supply circuit 13P and the electric power supply circuit 11P.

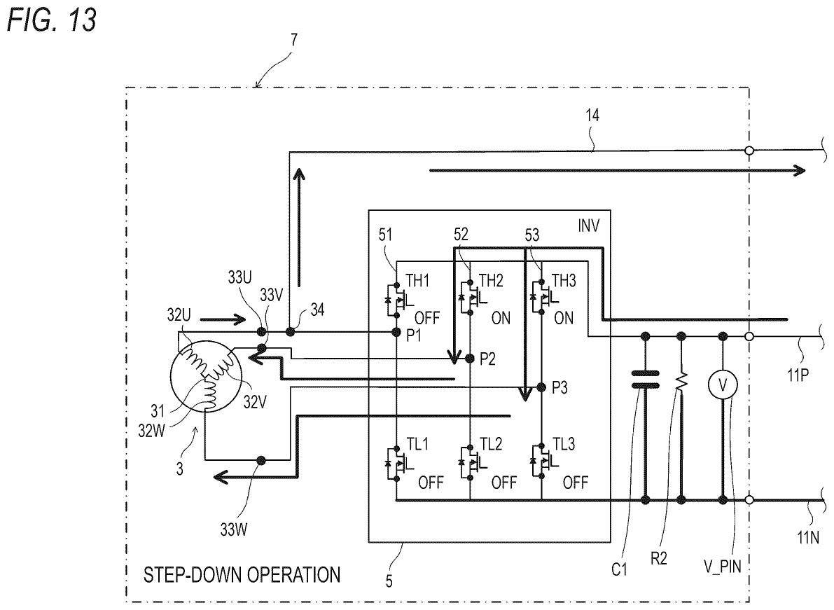

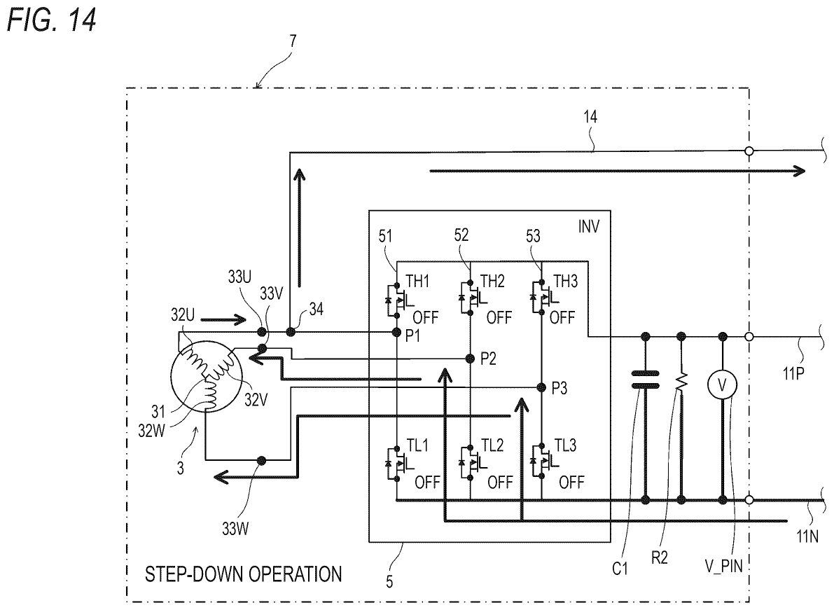

Here, in order to drive the auxiliary device 4 having a base voltage of 800 V, it is necessary to step down the voltage of 1200 V to 800 V, which is the base voltage of the auxiliary device 4. Therefore, the control unit 10 performs high-frequency switching of the second high-side switch TH2 and the third high-side switch TH3 to perform a step-down operation of switching between ON states of the second high-side switch TH2 and the third high-side switch TH3 shown in FIG. 13 and OFF states of the second high-side switch TH2 and the third high-side switch TH3 shown in FIG. 14. Note that the other switches TH1 and TL1 to TL3 of the inverter 5 are maintained in the OFF state.

As a result, the energy stored in the coils 32U, 32V, and 32W when the second high-side switch TH2 and the third high-side switch TH3 are in the ON state shown in FIG. 13 is released when the second high-side switch TH2 and the third high-side switch TH3 are in the OFF state shown in FIG. 14, so that the voltage of 1200 V supplied from the charge terminals 131P and 131N is stepped down to 800 V and supplied from the three-phase motor 3 to the auxiliary device 4 via the branch circuit 14, the connecting flow path 15, and the auxiliary device drive circuit 12P.

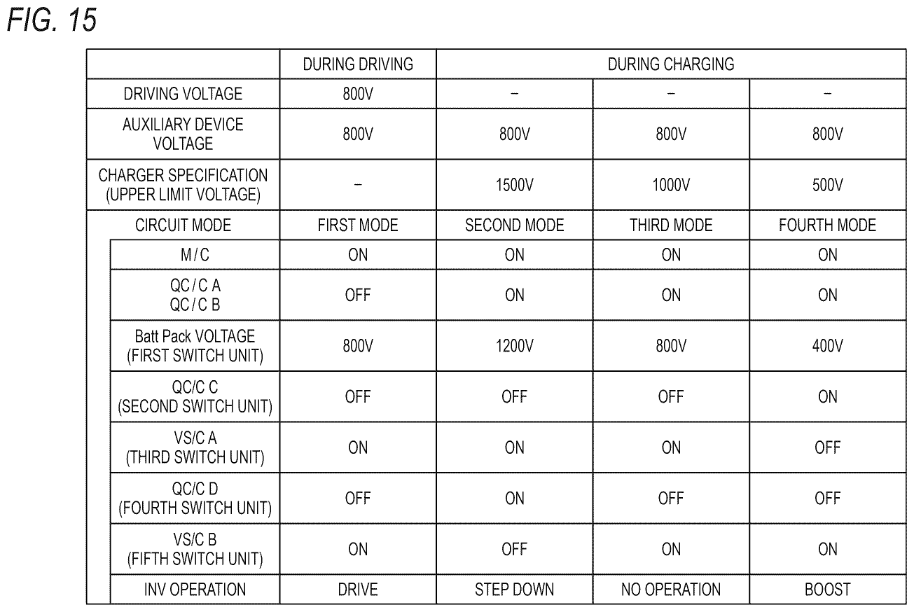

FIG. 15 is a table summarizing the states of the switches and the contactors in each mode of the power storage system 1 of the first embodiment.

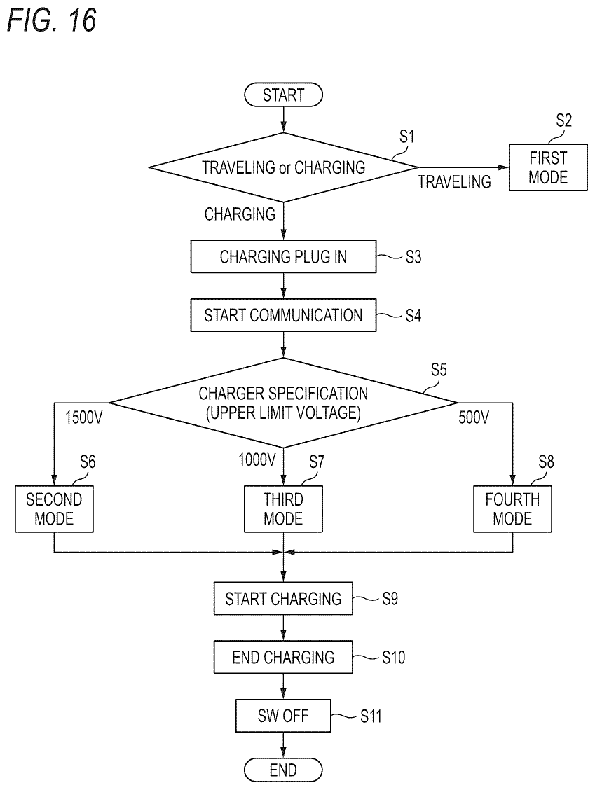

FIG. 16 is a flowchart showing a control flow of the power storage system 1.

First, it is detected whether the electric vehicle including the power storage system 1 is in a traveling mode or a charging mode (step S1). In the traveling mode, for example, a user presses a power switch while depressing a brake pedal of the electric vehicle. If the traveling mode is detected in step S1, the circuit mode of the power storage system 1 is set to the first mode (step S2).

On the other hand, if the charging mode is detected in step S1, and when it is detected that a charging plug is inserted into the charge terminals 131P, 131N (step S3), the control unit 10 starts communication with the charging equipment (step S4) and obtains charger specifications of the charging equipment (step S5). If an upper limit voltage of the charger is 1500 V in step S5, the circuit mode of the power storage system 1 is set to the second mode (step S6); if the upper limit voltage is 1000 V, the circuit mode of the power storage system 1 is set to the third mode (step S7); and if the upper limit voltage is 500 V, the circuit mode of the power storage system 1 is set to the fourth mode (step S8).

When the mode setting of the power storage system 1 is completed, charging is started (step S9), and when charging is completed (step S10), all the switches and contactors of the power storage system 1 are turned off to end the processing (step S11).

In this way, according to the power storage system 1 of the first embodiment, regardless of whether the external charging equipment is a system that charges at the first voltage (400 V charging), a system that charges at the second voltage (800 V charging), or a system that charges at the third voltage (1200 V charging), a connection method of the plurality of power storage units 21 can be switched using the first switch unit 41 (S/C_A, S/C_B, S/C_C, S/C_D, S/C_E, S/C_F, S/C_G, S/C_H), thereby enabling appropriate charging according to the voltage state of the charging equipment. That is, charging can be performed without passing through any voltage converter during charging, efficiency deterioration due to a voltage converter can be avoided, and it is possible to eliminate a voltage converter for charging.

Since the DC power supply circuit 13P on the positive electrode side connected to the first connection portion 111P positioned on the electric power transmission path between the inverter 5 and the battery 2 includes the branch circuit 14 connected to a coil of any one phase of the three-phase motor 3, voltage conversion can be performed using the three-phase motor 3 and the inverter 5. Particularly, by providing the fourth switch unit 44 (contactor QC/C_D) and the fifth switch unit 45 (contactor VS/C_B), it is possible to not only boost but also step down the voltage by utilizing the coils of the three-phase motor 3, even when the voltage state of the charging equipment and the operating voltage of the auxiliary device 4 are different from each other. In this way, a dedicated voltage converter can be eliminated, thereby reducing the manufacturing cost.

### Second Embodiment

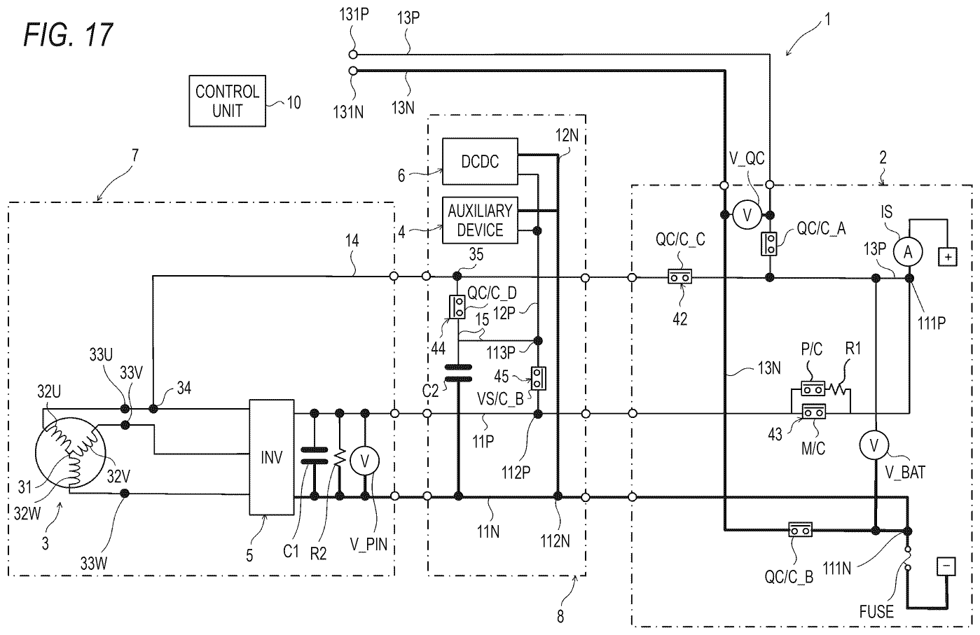

Next, the power storage system 1 according to the second embodiment will be described with reference to FIGS. 17 to 22. Here, the same reference numerals as in the first embodiment are used for the same configurations as in the first embodiment, and the description of the first embodiment may be incorporated.

In the power storage system 1 according to the first embodiment, when the contactor QC/C_A, which is the main switch for charging, and the main contactor M/C, which is the main switch for battery 2, are viewed with respect to the battery 2, the contactor QC/C_A is connected in series to the main contactor M/C. However, in the power storage system 1 according to the second embodiment, the contactor QC/C_A is connected in parallel to the main contactor M/C as shown in FIG. 17.

In the power storage system 1 according to the second embodiment, during charging with the first voltage (400 V) or the third voltage (1200 V), the first voltage (400 V) or the third voltage (1200 V), which is the charge voltage of the battery 2, can be separated, by the main contactor M/C, from the second voltage (800 V) boosted by the three-phase motor 3 and the inverter 5, and thus the contactor VS/C_A of the first embodiment is no longer required. In the power storage system 1 according to the second embodiment, the contactor QC/C_A, the contactor QC/C_B, the second switch unit 42 (contactor QC/C_C), the second voltage sensor V_BAT, and the third voltage sensor V_QC are arranged in the battery 2.

The second embodiment is similar to the first embodiment in that eight switches (S/C_A, S/C_B, S/C_C, S/C_D, S/C_E, S/C_F, S/C_G, S/C_H) constitute an example of the first switch unit 41, the contactor QC/C_C is an example of the second switch unit 42, the contactor QC/C_D is an example of the fourth switch unit 44, and the contactor VS/C B is an example of the fifth switch unit 45, and differs from the first embodiment in that the main contactor M/C is an example of the third switch unit 43.

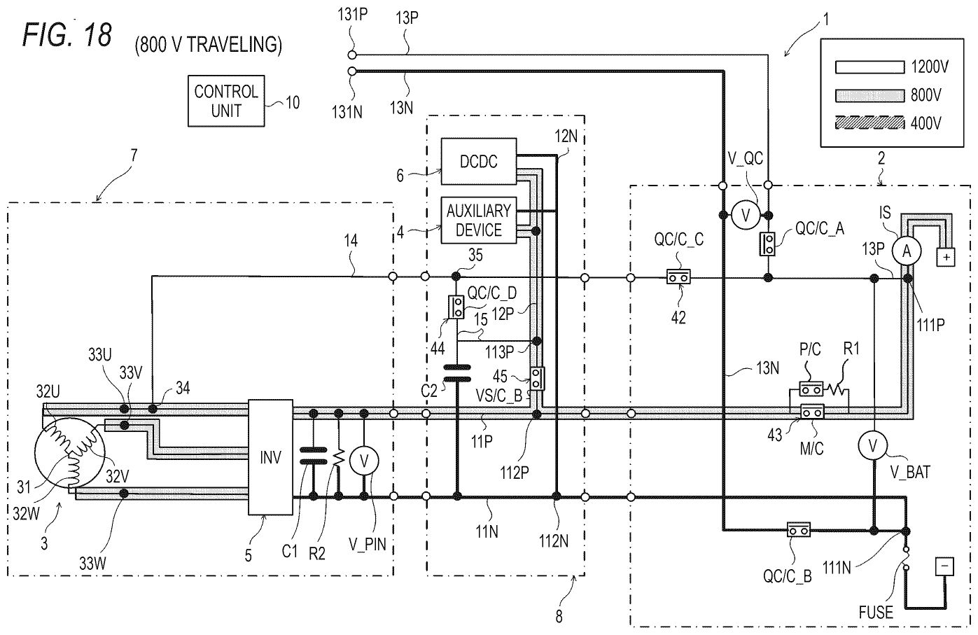

An operation of the power storage system 1 according to the second embodiment will be described with reference to FIGS. 18 to 21.

FIG. 18 is a diagram showing a flow of a current during traveling (800 V traveling) of an electric vehicle including the power storage system 1 according to the second embodiment.

As described above, the electric vehicle including the power storage system 1 drives the three-phase motor 3 and the auxiliary device 4 with the base voltage of 800 V, and during traveling, the battery 2 is controlled to the 800 V start-up state shown in FIG. 5. The control unit 10 turns on the third switch unit 43 (main contactor M/C) and the fifth switch unit 45 (contactor VS/C_B), and turns off the contactor QC/C_A, the contactor QC/C_B, the second switch unit 42 (contactor QC/C_C), and the fourth switch unit 44 (contactor QC/C_D). A circuit mode in this case is called an eleventh mode.

In this eleventh mode, a voltage of 800 V is supplied from the battery 2 to the three-phase motor 3 via the inverter 5, enabling the electric vehicle to travel. In this case, the auxiliary device 4 is driven by a voltage of 800 V supplied from the battery 2 via the electric power supply circuits 11P and 11N and the auxiliary device drive circuits 12P and 12N.

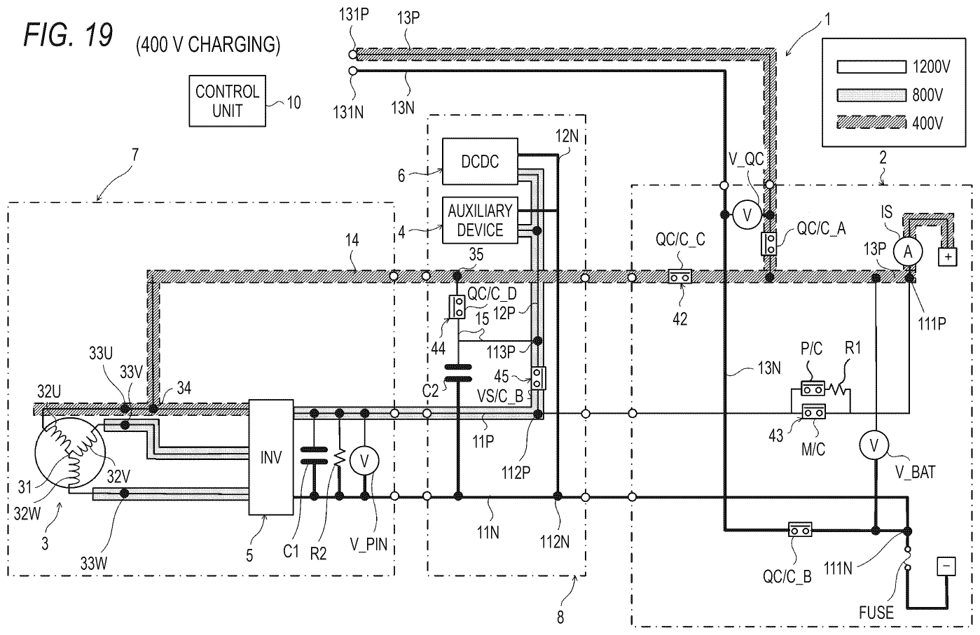

FIG. 19 is a diagram showing a flow of a current during charging at the first voltage (400 V charging) of the electric vehicle including the power storage system 1 according to the second embodiment.

When charging with a 400 V class charging equipment, the battery 2 is controlled to a 400 V start-up state shown in FIG. 4. The control unit 10 turns on the contactor QC/C_A, the contactor QC/C_B, the second switch unit 42 (contactor QC/C_C), and the fifth switch unit 45 (contactor VS/C_B), and turns off the third switch unit 43 (main contactor M/C) and the fourth switch unit 44 (contactor QC/C_D). A circuit mode in this case is called a fourteenth mode. As a result, a voltage of 400 V is supplied from the charge terminals 131P and 131N to the battery 2 via the DC power supply circuit 13P and the electric power supply circuit 11P, and a voltage of 400 V is supplied to the coil 32U via the DC power supply circuit 13P and the branch circuit 14.

Here, in order to drive the auxiliary device 4 having a base voltage of 800 V, it is necessary to boost the voltage of 400 V to 800 V, which is the base voltage of the auxiliary device 4. The booster operation is as explained in the first embodiment with reference to FIGS. 9 and 10, and detailed explanation thereof will be omitted. By the booster operation, the voltage of 400 V supplied from the charge terminals 131P and 131N is boosted to 800 V and supplied from the inverter 5 to the auxiliary device 4 via the electric power supply circuit 11P and the auxiliary device drive circuit 12P.

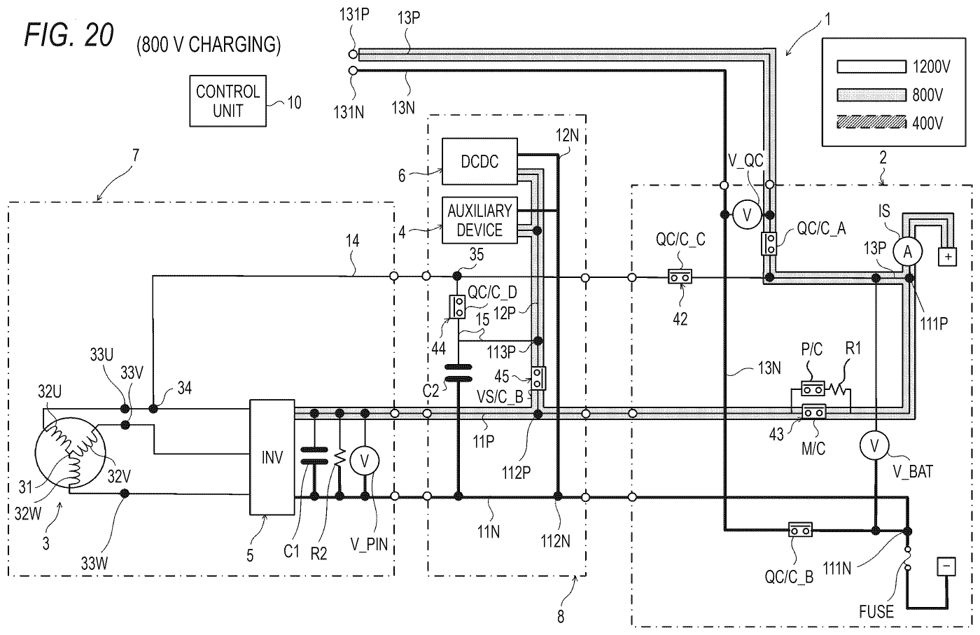

FIG. 20 is a diagram showing a flow of a current during charging at the second voltage (800 V charging) of the electric vehicle including the power storage system 1 according to the second embodiment.

When charging with an 800 V class charging equipment, the battery 2 is controlled to an 800 V start-up state shown in FIG. 5. The control unit 10 turns on the third switch unit 43 (main contactor M/C), the contactor QC/C_A, the contactor QC/C_B, and the fifth switch unit 45 (contactor VS/C_B), and turns off the second switch unit 42 (contactor QC/C_C) and the fourth switch unit 44 (contactor QC/C_D). A circuit mode in this case is called a thirteenth mode. As a result, a voltage of 800 V is supplied from the charge terminals 131P and 131N to the battery 2 via the DC power supply circuit 13P and the electric power supply circuit 11P, and a voltage of 800 V is supplied to the auxiliary device 4 via the DC power supply circuit 13P, the electric power supply circuit 11P, and the auxiliary device drive circuit 12P.

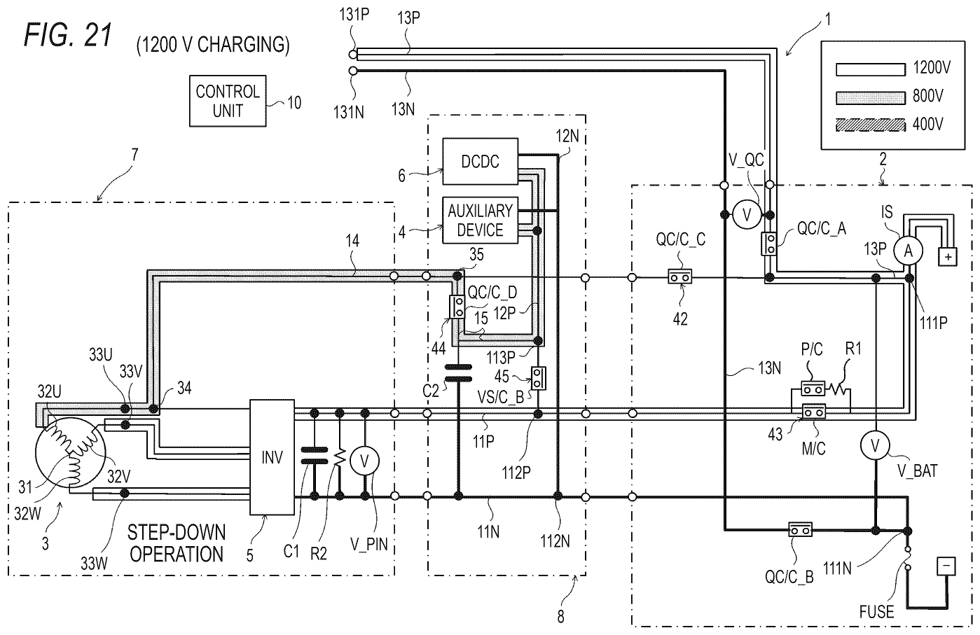

FIG. 21 is a diagram showing a flow of a current during charging at the third voltage (1200 V charging) of the electric vehicle including the power storage system 1 according to the second embodiment.

When charging with a 1200 V class charging equipment, the battery 2 is controlled to a 1200 V start-up state shown in FIG. 6. The control unit 10 turns on the contactor QC/C_A, the contactor QC/C_B, the third switch unit 43 (main contactor M/C), and the fourth switch unit 44 (contactor QC/C_D), and turns off the second switch unit 42 (contactor QC/C_C) and the fifth switch unit 45 (contactor VS/C_B). A circuit mode in this case is called a twelfth mode. As a result, a voltage of 1200 V is supplied from the charge terminals 131P and 131N to the battery 2 via the DC power supply circuit 13P and the electric power supply circuit 11P, and a voltage of 1200 V is supplied to the inverter 5 via the DC power supply circuit 13P and the electric power supply circuit 11P.

Here, in order to drive the auxiliary device 4 having a base voltage of 800 V, it is necessary to step down the voltage of 1200 V to 800 V, which is the base voltage of the auxiliary device 4. The step-down operation is as explained in the first embodiment with reference to FIGS. 13 and 14, and detailed explanation thereof will be omitted. By the step-down operation, the voltage of 1200 V supplied from the charge terminals 131P and 131N is stepped down to 800 V and supplied from the three-phase motor 3 to the auxiliary device 4 via the branch circuit 14, the connecting flow path 15, and the auxiliary device drive circuit 12P.

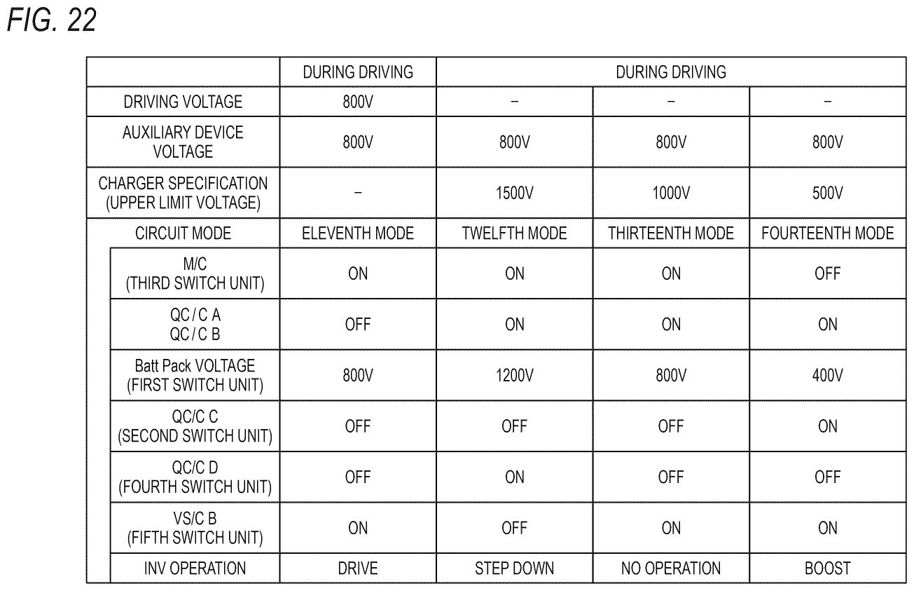

FIG. 22 is a table summarizing the states of the switches and the contactors in each mode of the power storage system 1 of the second embodiment.

In this way, similar to the first embodiment, according to the power storage system 1 of the second embodiment, regardless of whether the external charging equipment is a system that charges at the first voltage (400 V charging), a system that charges at the second voltage (800 V charging), or a system that charges at the third voltage (1200 V charging), a connection method of the plurality of power storage units 21 can be switched using the first switch unit 41 (S/C_A, S/C_B, S/C_C, S/C_D, S/C_E, S/C_F, S/C_G, S/C_H), thereby enabling appropriate charging according to the voltage state of the charging equipment. That is, charging can be performed without passing through any voltage converter during charging, efficiency deterioration due to a voltage converter can be avoided, and it is possible to eliminate a voltage converter for charging.

Since the DC power supply circuit 13P on the positive electrode side connected to the first connection portion 111P positioned on the electric power transmission path between the inverter 5 and the battery 2 includes the branch circuit 14 connected to a coil of any one phase of the three-phase motor 3, voltage conversion can be performed using the three-phase motor 3 and the inverter 5. Particularly, by providing the fourth switch unit 44 (contactor QC/C_D) and the fifth switch unit 45 (contactor VS/C_B), it is possible to not only boost but also step down the voltage by utilizing the coils of the three-phase motor 3, even when the voltage state of the charging equipment and the operating voltage of the auxiliary device 4 are different from each other. In this way, a dedicated voltage converter can be eliminated, thereby reducing the manufacturing cost.

Although the various embodiments have been described above with reference to the drawings, it is needless to say that the present disclosure is not limited to these examples. It is apparent that those skilled in the art can conceive of various modifications and changes within the scope described in the claims, and it is understood that such modifications and changes naturally fall within the technical scope of the present disclosure. In addition, respective constituent elements in the above-described embodiment may be freely combined without departing from the gist of the disclosure.

For example, in the above embodiments, the control unit 10 has been described as communicating with the charging equipment, but the communication method may be any communication method such as CAN communication.

In the present description, at least the following matters are described. Although corresponding constituent elements or the like in the embodiment described above are shown in parentheses, the present disclosure is not limited thereto.
(1) A power storage system (power storage system 1) including:
   a battery (battery 2) including a plurality of power storage units (power storage units 21) and a switch group (first switch unit 41) configured to switch a connection state of the plurality of power storage units between a first voltage state (400 V), a second voltage state, and a third voltage state, the first voltage state being a state in which the battery is configured to be charged at a first voltage, the second voltage state being a state in which the battery is configured to be charged at a second voltage (800 V) higher than the first voltage, the third voltage state being a state in which the battery is configured to be charged at a third voltage (1200 V) higher than the second voltage;
   a three-phase motor (three-phase motor 3) in which coils of three phases (coils 32U, 32V, 32W) are connected at a neutral point (neutral point 31), the three-phase motor being driven by electric power supplied from the battery;
   an inverter (inverter 5) connected on an electric power transmission path (electric power supply circuits 11P, 11N) between the battery and the three-phase motor;
   a DC power supply circuit (DC power supply circuits 13P, 13N) connected to a first connection portion (first connection portions 111P, 111N) positioned on an electric power transmission path between the inverter and the battery;
   an auxiliary device (auxiliary device 4) configured to be driven by DC power from the battery and an external power supply; and
   an auxiliary device drive circuit (auxiliary device drive circuit 12P) that is connected to a second connection portion (second connection portion 112P) on an electric power transmission path between the inverter and the first connection portion and supplies electric power to the auxiliary device, in which
   the DC power supply circuit on a positive electrode side includes a branch circuit (branch circuit 14) connected to a coil of one phase among the coils of three phases at a third connection portion (third connection portion 34),
   the branch circuit is connected to the auxiliary device drive circuit at a fourth connection portion (fourth connection portion 113P) via a first changeover switch (fourth switch unit 44), and
   the auxiliary device drive circuit has a second changeover switch (fifth switch unit 45) between the second connection portion (second connection portion 112P) and the fourth connection portion (fourth connection portion 113P).

According to (1), it is possible to appropriately perform charging according to a voltage state of charging equipment by switching, by the switch group, a connection method of the plurality of power storage units regardless of whether the external charging equipment is a system that performs charging at the first voltage, a system that performs charging at the second voltage, or a system that performs charging at the third voltage. That is, charging can be performed without passing through any voltage converter during charging, efficiency deterioration due to a voltage converter can be avoided, and it is possible to eliminate a voltage converter for charging.

Since the DC power supply circuit on the positive electrode side connected to the first connection portion positioned on the electric power transmission path between the inverter and the battery includes the branch circuit connected to a coil of any one phase among the three-phase motor, voltage conversion can be performed using the three-phase motor and the inverter. Particularly, by providing the first changeover switch and the second changeover switch, it is possible to not only boost but also step down the voltage by utilizing the coils of the three-phase motor, even when the voltage state of the charging equipment and the operating voltage of the auxiliary device are different from each other. In this way, a dedicated voltage converter can be eliminated, thereby reducing the manufacturing cost.
(2) The power storage system according to (1), in which
   the auxiliary device operates at the second voltage.

According to (2), when charging with the second voltage and when driving the three-phase motor with the second voltage, voltage conversion can be eliminated. No matter when charging at the first voltage or charging at the third voltage, the auxiliary device can be driven at the second voltage, so that an amount of voltage conversion when boosting and stepping down can be reduced. In this way, it is possible to prevent the system from becoming larger.
(3) The power storage system according to (2), further including:
   a control unit (control unit 10) configured to control the switch group, the first changeover switch, the second changeover switch, and the inverter, in which
   the control unit controls the inverter and sets the first changeover switch to a cut-off state and the second changeover switch to a connection state to boost the first voltage to generate the second voltage when the battery is charged at the first voltage, and
   the control unit controls the inverter and sets the first changeover switch to a connection state and the second changeover switch to a cut-off state to step down the third voltage to generate the second voltage when the battery is charged at the third voltage.

According to (3), since the voltage can be boosted or stepped down by controlling the inverter, other semiconductor switches are not required, and the manufacturing cost can be reduced.
(4) The power storage system according to (3), in which
   the branch circuit has a third changeover switch (second switch unit 42) configured to cut off electric power transmission between the branch circuit and the DC power supply circuit on the positive electrode side,
   a fourth changeover switch (third switch unit 43) is provided in the electric power transmission path between the inverter and the battery between the first connection portion (first connection portion 111P) and the second connection portion (second connection portion 112P), and
   the control unit sets the third changeover switch to a connection state and the fourth changeover switch to a cut-off state when the battery is charged at the first voltage, and sets the third changeover switch to a cut-off state and the fourth changeover switch to a connection state when the battery is charged at the third voltage.

According to (4), when charging at the first voltage or the third voltage, the third changeover switch and the fourth changeover switch can separate portions at the first voltage state or the third voltage state from portions at the second voltage state.
(5) The power storage system according to (4), in which
   the control unit sets the first changeover switch and the third changeover switch to the cut-off state and sets the second changeover switch and the fourth changeover switch to the connection state when the battery is charged at the second voltage and when the three-phase motor is driven at the second voltage.

According to (5), it is possible to drive the auxiliary device at the second voltage, charge the battery at the second voltage, and drive the three-phase motor at the second voltage without supplying electric power to the branch circuit.
(6) The power storage system according to (1), in which
   one end side of the first changeover switch is connected to the branch circuit, and the other end side of the first changeover switch is connected to a negative electrode side of the electric power transmission path (electric power supply circuit 11N) between the battery and the three-phase motor via a capacitor.

According to (6), the electric power supplied to the auxiliary device can be smoothed.

1. A power storage system comprising:
a battery including a plurality of power storage units and a switch group configured to switch a connection state of the plurality of power storage units between a first voltage state, a second voltage state, and a third voltage state, the first voltage state being a state in which the battery is configured to be charged at a first voltage, the second voltage state being a state in which the battery is configured to be charged at a second voltage higher than the first voltage, the third voltage state being a state in which the battery is configured to be charged at a third voltage higher than the second voltage;
a three-phase motor in which coils of three phases are connected at a neutral point, the three-phase motor being driven by electric power supplied from the battery;
an inverter connected to an electric power transmission path between the battery and the three-phase motor;
a DC power supply circuit connected to a first connection portion positioned on an electric power transmission path between the inverter and the battery;
an auxiliary device configured to be driven by DC power from the battery and an external power supply; and
an auxiliary device drive circuit that is connected to a second connection portion on an electric power transmission path between the inverter and the first connection portion and supplies electric power to the auxiliary device, wherein
the DC power supply circuit on a positive electrode side includes a branch circuit connected to a coil of one phase among the coils of three phases at a third connection portion,
the branch circuit is connected to the auxiliary device drive circuit at a fourth connection portion via a first changeover switch, and
the auxiliary device drive circuit has a second changeover switch between the second connection portion and the fourth connection portion.

2. The power storage system according to claim 1, wherein
the auxiliary device operates at the second voltage.

3. The power storage system according to claim 2, further comprising:
a control unit configured to control the switch group, the first changeover switch, the second changeover switch, and the inverter, wherein
the control unit controls the inverter and sets the first changeover switch to a cut-off state and the second changeover switch to a connection state to boost the first voltage to generate the second voltage when the battery is charged at the first voltage, and
the control unit controls the inverter and sets the first changeover switch to a connection state and the second changeover switch to a cut-off state to step down the third voltage to generate the second voltage when the battery is charged at the third voltage.

4. The power storage system according to claim 3, wherein
the branch circuit has a third changeover switch configured to cut off electric power transmission between the branch circuit and the DC power supply circuit on the positive electrode side,
a fourth changeover switch is provided in the electric power transmission path between the inverter and the battery between the first connection portion and the second connection portion, and
the control unit sets the third changeover switch to a connection state and the fourth changeover switch to a cut-off state when the battery is charged at the first voltage, and sets the third changeover switch to a cut-off state and the fourth changeover switch to a connection state when the battery is charged at the third voltage.

5. The power storage system according to claim 4, wherein
the control unit sets the first changeover switch and the third changeover switch to the cut-off state and sets the second changeover switch and the fourth changeover switch to the connection state, when the battery is charged at the second voltage and when the three-phase motor is driven at the second voltage.

6. The power storage system according to claim 1, wherein
one end side of the first changeover switch is connected to the branch circuit, and the other end side of the first changeover switch is connected to a negative electrode side of the electric power transmission path between the battery and the three-phase motor via a capacitor.
